(19) United States
(12) Patent Application Publication
(10) Pub. No.: US 2010/0036712 A1
(43) Pub. Date: Feb. 11, 2010

(54) Method of and system for capturing data

(76) Inventor: Daniel Albert Arkind Abrahamsohn, San Francisco, CA (US)

Correspondence Address: INNOVATION MANAGEMENT SCIENCES, P. O. BOX 1169, LOS ALTOS, CA, 94023-1169, US

(21) Appl. No.: 12/455,427

(22) Filed: Jun. 1, 2009

Related U.S. Application Data
(63) Continuation of application No. 11/508,742, filed on Aug. 23, 2006, now abandoned.
Application No. 11/508,742 is a continuation-in-part of application No. 11/066,952, filed on Feb. 25, 2005, now abandoned.
(60) Provisional application No. 60/548,710, filed on Feb. 27, 2004.
(60) Provisional application No. 60/717,144, filed on Sep. 14, 2005.

(51) Int. Cl. G06Q 99/00; G06Q 10/00; G06F 17/30; G06F 17/40

(52) U.S. Cl. 705/10; 705/1; 707/5; 707/E17.017; 707/E17.044

(57) ABSTRACT

In one embodiment of the invention, a company could create a system whereby individual job seekers voluntarily enter their own career history information as well as their implicit preference information. In addition to these job-seeker entered profiles, a company could create technology to aggregate job listings from multiple sources. In turn a company could create a “standard application” interface wherein job seekers could apply to jobs at many different destination organizations using their pre-established profile. In this way the company could capture information about what jobs candidates were applying for. The company could leverage this information to make higher quality matches between people and jobs, both in terms of recommending jobs for candidates as well as candidates for jobs, providing the underlying data to enable the company to charge for data offerings, and to enable the company to employ matching techniques of the invention to find highly desirable candidates.

### RELATED APPLICATIONS

The present application is a continuation-in-part of, and claims priority under 35 U.S.C. §120 to U.S. non-provisional patent application bearing Ser. No. 11/066,952, filed Feb. 25, 2005, which claims priority under 35 U.S.C. §119(e) to U.S. provisional patent application bearing Ser. No. 60/548,710, filed Feb. 27, 2004. The present application also claims priority under 35 U.S.C. §119(e) to U.S. provisional patent application bearing Ser. No. 60/717,144, filed Sep. 14, 2005, and claims priority under 35 U.S.C. §§120 and 365(c) to PCT Application bearing application number PCT/US05/006172, filed Feb. 25, 2005, and designating multiple countries including the United States. The aforementioned U.S. patent applications are hereby incorporated by reference in their entirety.

### FIELD OF THE INVENTION

The invention relates generally to a method of and system for collecting data from multiple sources and improving the ranking and matching of documents based on re-using the meta data obtained during data collection, sorting and review processes (which for expediency are sometimes collectively referred to as “collaborative filtering”).

### BACKGROUND OF THE INVENTION

There are currently on-line employment advertisement systems that are accessible through the World Wide Web. For example, some newspapers publish classified employment advertisements in electronic format on the World Wide Web. These newspaper Web-sites generally post a job description and request a resume response either via electronic mail, facsimile, or regular mail. Some newspaper Web-sites also provide a Web-browser based interface to allow applicants to respond online.

Some companies provide online job boards on which employers can post job advertisements and where job searchers can respond and/or post their resumes or curriculum vitae. Such online job boards, which are exemplified by www.monster.com, www.careerbuilder.com, and hotjobs.yahoo.com, typically lead a candidate through certain steps and parameters to qualified job postings by searching through job listings based on location, company, discipline, industry, and job titles. Once a job opening is selected, a candidate may submit an online job application by creating a new resume on-line or submitting a pre-created resume. In addition to applying to a specific job opening, applicants may elect to contribute their resumes into a “resume pool,” which is stored within the job board's “resume database.” This aggregated resume database of job seekers may be queried by the employers when searching for suitable candidates. Such job boards typically charge the employers on a subscription-fee and/or per-seat basis to access the aggregated resume pool. Some job boards sell access to resumes within the resume pool in bulk to employers. Some companies choose to use free or subscription-based resume database and research products to be able to access potential employees (i.e. the resume database at www.craigslist.com is free).

There are other means currently used by employers and recruiters to find well qualified candidates. Some companies (e.g. www.eliyon.com, www.zillionresumes.com) spider the public internet for profile or resume information. Some other employers and recruiters collect profile information through social networking Websites (e.g., www.linkedin.com, www.ryze.com).

In addition to posting job advertisements in newspaper Web-sites and online job boards, many employers post job advertisements on their own Web-sites, alumni Web-sites, online groups, RSS feeds, etc. These job advertisements are similar to those posted on job boards, and typically include a description of the position available and a request to submit resumes to either an email address, a postal address or through a browser based interface to submit their resumes online.

In addition to posting job advertisements on the Web and other media, many employers have internal referral programs to reward both their employees and those affiliated with their company for referring in candidates that the company ultimately chooses to hire.

Almost all of the resumes stored within the aforementioned job boards have been received via direct submission by job applicants, who may be submitting the resumes directly to the resume pool, or in response to specific job postings. While many highly qualified candidates submit their resumes to the resume pool or in response to specific job postings, it is believed that in many cases the most highly qualified candidates for a position are not actively monitoring the classified job postings on online job boards, nor are they submitting their resumes to their resume databases. These qualified candidates are often referred to as passive job seekers. Some employers desiring to include passive job seekers in their recruiting effort may find the online resume database ineffective, and they often contract search firms or professional recruiting agencies to identify and contact these passive job seekers.

Some employers find the job board's online resume databases and classified offerings ineffective because they generate too many resumes for the employers to review. As a result, employers are not able to separate which candidates are best qualified for a given position. A single job posting on a job board may attract hundreds or thousands of qualified applicants, few of which have the required qualifications. Oftentimes, employers miss out on the best qualified candidates as it simply takes too long to sort through the information to find the most appropriate candidates. There are many statistical techniques and software solutions available to employers for analyzing the resumes and selecting candidates based on how closely their resumes match their job requirements. But even the best of such statistical techniques are less than perfect.

Accordingly, there exists a need for a means to match candidates beyond the qualifications listed on their resumes. Additionally, sometimes the best candidates simply cannot be identified through traditional means like classifieds and resume databases, thus a need exists for a method of and system for enabling employers/recruiters to easily identify and contact the most appropriate candidates who are not currently trafficking through these job boards and other online employment systems.

### SUMMARY OF THE INVENTION

The present invention relates to a computer implemented method of and system for collecting, identifying, searching, ranking, matching, pricing and selling electronic documents (such as resumes) obtained from a multiple constituents (i.e., companies, employers, independent recruiters) that employ a multitude of means to collect documents (e.g., internal referrals, direct submissions, classified venues, third party agencies, etc.), and a computer implemented method of and system for ranking sets of documents using meta data obtained as the documents were collected, processed, verified, approved, annotated and/or rejected for their intended use.

An aspect of the invention provides a system for and method of populating a document pool with resumes obtained from multiple constituents using various means to collect documents. In particular, according to an embodiment, the invention provides a system for and method of populating an online resume pool with resumes collected by multiple employers that obtained the resumes from various means, such as internal referrals, direct submissions, classified venues, third party agencies, etc. In one embodiment, incentives are provided to contributors that contribute resumes to the online resume pool. The contributors may be individuals who contribute their own resumes, and/or employers or professional recruiters that contribute resumes collected previously through job postings, internal referrals, direct submissions, search firms or any other means. The incentives may include unlimited access to the resumes contributed by participating affiliated contributors, database subscriptions, credits that can be used for accessing the online resume pool or for accessing detailed records, and/or licenses to use certain software application(s). The hypothesis is that employers would be incentivized to contribute resumes that they no longer have any use for if they could receive something in return.

According to another aspect of the invention, an Applicant Tracking System (ATS) software is provided to multiple constituents (e.g., contributors, companies, recruiters) with reduced fees or without any fees as an incentive for them to contribute resumes. The ATS software may provide functionalities such as resume reviewing, resume searching, resume ranking according to pre-established criteria, interview scheduling, referral gathering, collection of interviewer feedback, reporting, etc. In addition, the ATS software may automatically generate letters acknowledging receipt of the candidates' applications, generate emails to turn down applicants once a position is filled, and store the resumes as permanent records for the company's own use in the future. Furthermore, the ATS software stores in the online aggregated resume database the resumes of applicants that are no longer in consideration for a position. Note that the ATS software may be used by multiple constituents or distributed to multiple constituents such that the ATS software collects resumes and other data from a network of constituents/contributors.

An important feature of the ATS software is that the software keeps track of certain meta data of each applicant that is entered into the system. The meta data generally includes information not typically reflected on a resume and not typically provided by the applicant to other potential employers. Meta data may include information such as, but not limited to, Source and Referral Meta Data (e.g., the identity and quality of a referral source), Performance Meta Data (e.g., Was the applicant's resume reviewed or was the applicant interviewed? Was the applicant offered a position after an interview?), and Preference Meta Data (e.g., What types of positions are the applicants applying for? Where are these jobs located? Are the job descriptions similar to the position the employer is trying to fill?). The ATS software collects meta data from multiple constituents and stores the meta data in the online resume pool as well, although in one embodiment access to the meta data may be limited to those having permission from the operator of the online resume pool or the applicants themselves. Heretofore, there has never been a system for and method of obtaining the referral source, historical performance, and actual preference of job applicants from multiple entities (e.g., employers and recruiters) and storing such information in an online resume pool.

An aspect of the invention provides a system for and method of searching through and differentiating similar data. According to an embodiment, the invention provides a system for and method of identifying highly relevant applicants or candidates from a resume pool where the resumes have been collected through a multitude of means by multiple entities that employ an ATS software to help them manage and process their resumes and their interviewing and fulfillment processes. In particular, in one embodiment, the online resume pool provides a data store for storing meta data together with other applicant data (including resume data) collected from multiple constituents, and a search engine through which customers may search and access their own resumes lo as well as those submitted by other firms. The online resume pool may further include a software mechanism for combining meta data and resume data of the same applicant collected from multiple constituents.

In one embodiment, the search engine is configured to rank the search results based on the meta data associated with each resume. For instance, the meta data may indicate that a certain applicant is a “relevant” candidate because he/she is often selected for an interview, offered a position after an interview, and he/she has previously applied to similar jobs. In that case, the search engine may rank that candidate higher than candidates who have a less successful track record or dissimilar interests. In this way, the search engine is able to accurately rank the relevance and quality of candidates despite similarities in their stated qualifications and professional histories, and is more likely to present highly qualified candidates to the customers of the online resume pool than search engines that only employ prior art candidate matching/ranking methodologies based on resume data. In another embodiment, meta data may be used by a data filter mechanism to screen the applicants or candidates such that only certain applicants or candidates meeting certain meta data criteria may be presented to a user browsing the aggregated database.

According to one embodiment of the invention, customers of the online resume pool, who may include some or all contributors and/or other third party entities, are able to preview anonymous profiles of candidates identified as “matching” or “relevant” by the search engine for free. In particular, customers would only be able to access anonymous profiles for those candidates contributed by other constituents. Customers may then purchase the individual resumes corresponding to the anonymous profiles they deem appropriate. In one embodiment, the online resume pool may charge more for resumes that are identified as relevant by the search engine than it would for resumes that are not so identified.

According to another embodiment of the invention, the online resume pool provides an interface through which employers and applicants may make initial connections with each other without revealing the identities of either party. This is achieved by allowing employers to use the search engine to identify appropriate candidates but not view complete versions of an applicant's information, heretofore known as an anonymous profile. At this point, the employer may elect to forward a complete or anonymized description of an available position to the individuals whose resumes are stored in the online resume pool with or without fees. Recipients of copies of the job descriptions may opt to respond to the available positions by authorizing the employers to view their complete profiles (at which point a fee would typically be charged.) The employer may then choose to transmit the full job description and reveal their identity to the candidates it deems appropriate to solicit interest. This is referred to herein as “double blind match.” Alternatively, recipients of the generic descriptions may respond to the available positions by authorizing one or more constituents (employers) using the resume pool to automatically purchase access to their complete profiles. In one embodiment, the online resume pool may charge a fee for sending the generic descriptions to candidates, and an additional fee for sending the full job description to candidates that they deemed relevant. In another embodiment of the invention, the online resume pool may charge for each candidate who responded to the job with interest.

According to yet another embodiment of the invention, the online resume pool provides an interface or software mechanism through which an employer may post a job opening on various online job boards and view resumes received from job applicants. In one embodiment, the employer may have to enter certain information (e.g., ranking criteria) in order to have the resumes they received ranked. In that embodiment, when the employer views the resumes they receive are ranked in accordance with said criteria. The online resume pool may use these same ranking criteria to rank other candidates within the resume pool that the employer does not currently have access to. The number and quality of appropriate candidates in the resume pool may be displayed to the employer, who may be encouraged to purchase additional resumes from the resume pool when he sees the number and quality of relevant candidates available from the resume pool.

According to yet another aspect of the invention, a system is created whereby individual job seekers voluntarily enter their own career history information as well as their implicit preference information. In addition to these job-seeker entered profiles, a company could create technology to aggregate job listings from multiple sources. In turn a company could create a “standard application” interface wherein job seekers could apply to jobs at many different destination organizations using their pre-established profile. In this way the company could capture information about what jobs candidates have been applying for. The company could leverage this information to make higher quality matches between people and jobs, both in terms of recommending jobs for candidates as well as candidates for jobs, providing the underlying data to enable the company to charge for data offerings, and to enable the company to employ matching techniques of the invention to find highly desirable candidates.

Heretofore, no one has applied these principles and techniques to the capture and re-use of data and meta data collected through productivity software, nor have they been applied to a paid resume database or job seeker/employer matching service.

Today, there are no vendors that are currently using applicant tracking technology to populate a common resume database pool, especially none providing this software for free. Furthermore, no vendor is using a collaborative filtering style approach in which user behaviors exhibited through the use of the applicant tracking system are monitored and re-used to make higher quality matches between job seekers and employers. The invention employs these techniques to build a valuable database of differentiated resumes, which can be used to make higher quality associations between the job seekers, employers and recruiters who use the invention, and upon which various business models can be built.

### BRIEF DESCRIPTION OF THE DRAWINGS

The invention will now be described with reference to the accompanying drawings which illustrate an example embodiment of the invention. Throughout the description, similar reference names may be used to identify similar elements.

FIG. 1A depicts an embodiment of the invention.

FIG. 1B depicts the data stored within the Aggregated Database of FIG. 1A in accordance with an embodiment of the invention.

FIG. 2 depicts a Private Data Network configuration according to an embodiment of the invention.

FIG. 3 depicts an example implementation of a system according to an embodiment of the invention.

FIG. 4 depicts an example record stored within the Aggregated Database of FIG. 3 according to an embodiment of the invention.

FIG. 5 depicts a flow diagram according to an embodiment of the invention.

FIG. 6 depicts an example computer system in which an embodiment invention can be implemented.

FIG. 7 depicts an example implementation of a client-side software application according to an embodiment of the invention.

FIG. 8 depicts the Anonymous Candidate Profile view of search results, in accordance with an embodiment of the invention.

FIG. 9 depicts the Full Profile View of search results, in accordance with an embodiment of the invention.

### DETAILED DESCRIPTION OF PREFERRED EMBODIMENTS

Various features of the invention, including specific implementations thereof, will now be described. Throughout the description, reference will be made to various implementation-specific details, including details of implementations of a Web-based resume aggregation system. These details are provided in order to fully illustrate preferred embodiments of the invention, and not to limit the scope of the invention.

The various features of the invention set forth herein may be embodied within a wide range of different types of multi-user computer systems, including cable television systems, satellite television systems, and systems in which information may be conveyed to users via Web pages, by synthesized voice or on wireless devices. Thus, it should be understood that the Web-based implementations described herein illustrate just one type of system in which features of the invention may be used.

A preferred embodiment of the invention is applicable to collecting, searching, and selling employment-related documents (e.g., cover letters, job applications, resumes, interview feedback). Thus, aspects of the invention will be described in the context of collecting, searching, and selling resumes. However, it should be understood that the principles of the invention described herein are applicable to other types of information and documents as well. For example, principles of the present invention are applicable to online dating services, and sales-lead referral and exchange services or any system through which the systematic review, approval or use of documents or profile information is conducted by multiple constituents. Furthermore, although a single server-based database is sometimes illustrated, it should be understood that multiple databases, distributed or peer-to-peer database system may be used to store, search, retrieve and re-sell the aggregated data and/or documents.

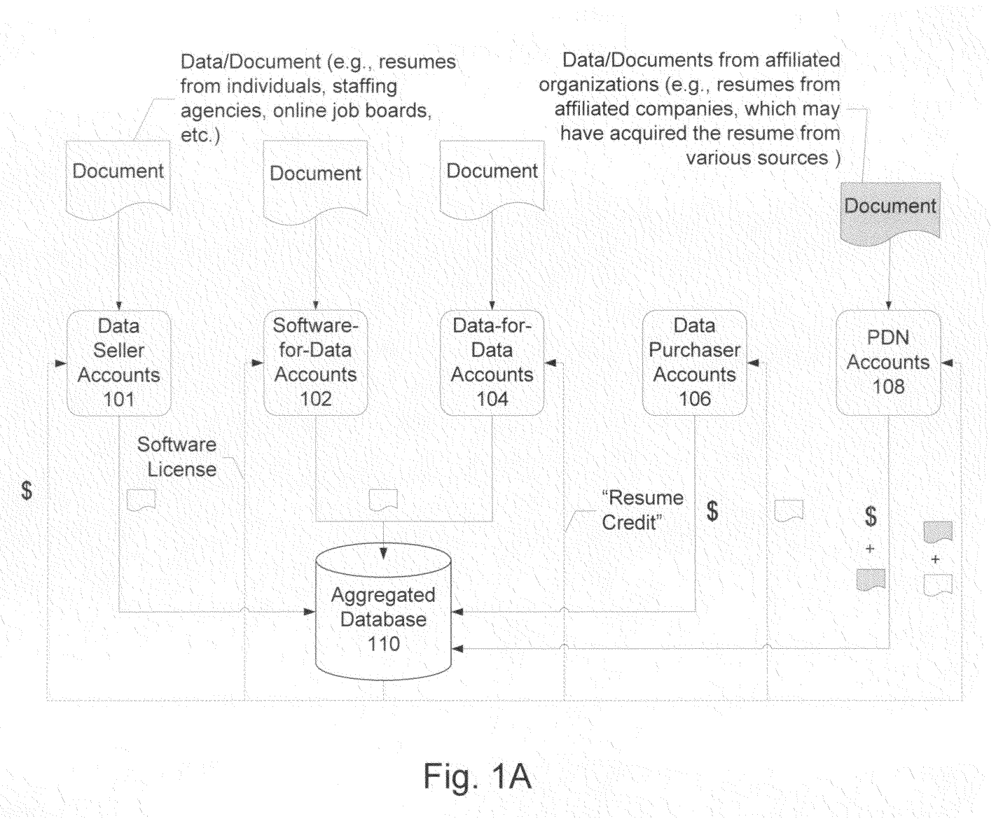

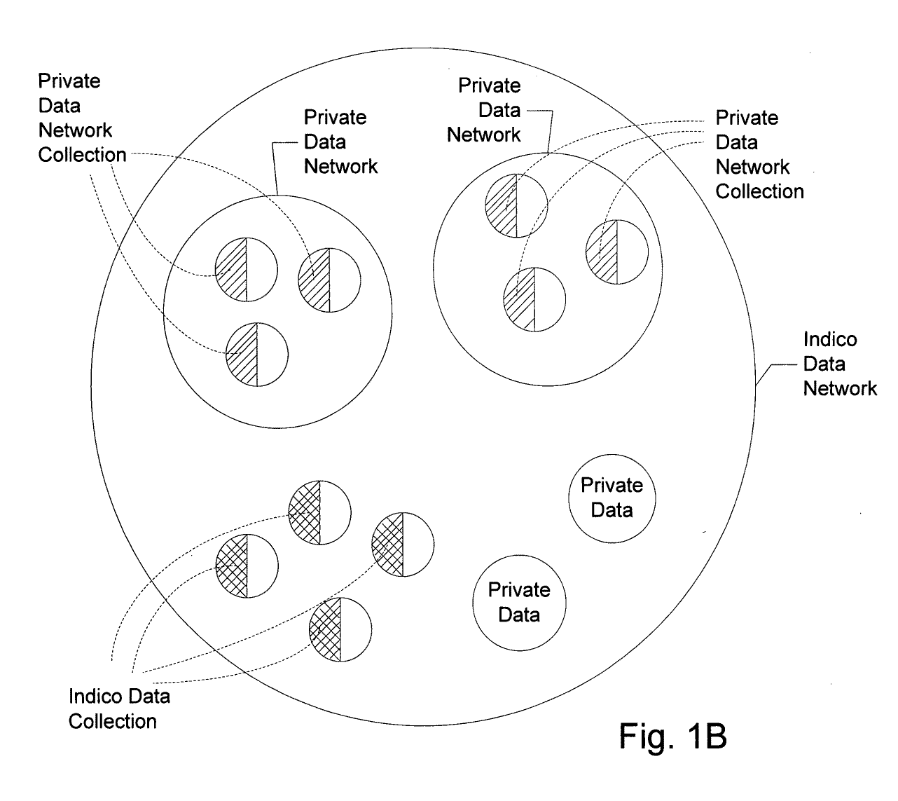

Referring now to FIG. 1A, there is shown an Aggregated Database 110 that is accessible to customers via a network (e.g., the Internet). For simplicity, the owner or operator of the Aggregated Database 110 is referred to herein as a Data Broker, a Document Broker, or Resume Pool Operator. Data and/or documents stored within the Aggregated Database 110 are depicted in FIG. 1B. The entire collection of data/documents stored within the Aggregated Database 110 is sometimes referred to herein as an Indico Data Network.

Customers authorized to access the Aggregated Database 110 are given customer accounts. There are many types of customer accounts. One type is called Data Seller Accounts 101. The holders of these accounts may contribute data and/or documents they have in their possession and receive cash credits, or credits to access services or data provided by the Resume Pool Operator, in return. The contributed data and/or documents are said to have become part of a semi-private data collection that is accessible by other account holders and is available for review and purchase. And, the contributing accounts are said to have contributed data and/or documents to the “Indico Data Collection”, which is also depicted in FIG. 1B. It is contemplated that individuals or companies using online job boards will sell/contribute resumes that they own through Data Seller Accounts 101.

Another type of customer account is called Software-for-Data accounts 102. As shown in FIG. 1A, Software-for-Data account holders receive the right to use productivity software or other software programs (provided by the Document Broker) for free or at some reduced cost. In return, the Software-for-Data accounts 102 contribute data and/or documents to the Indico Data Collection. In other words, productivity software licenses are used as an incentive for data or document contribution. An example of productivity software that the Document Broker may provide to the Software-for-Data accounts 102 in exchange for resumes is Application Tracking System (ATS) software. The Document Broker may provide the productivity software as an Application Service Provider and/or as enterprise software. It is contemplated that small to mid-sized companies, which typically desire but do not have the resources to purchase ATS software, will become contributor/participants through Software-for-Data accounts 102.

Note that Software-for-Data account holders may use the productivity software to process data/documents and may be required to contribute some of the processed data/documents to the Indico Data Collection. However, the Software-for-Data account holders may or may not contribute every piece of data/document processed by the productivity software to the Indico Data Collection. Some data and/or documents may be kept private and accessible to the account holder only. Private Data is depicted in FIG. 1B. Note that Software-for-Data account holders may retrieve data and/or documents from the Indico Data Collection. However, a fee may be applied for retrieving such records.

Another type of customer account is called Data-for-Data accounts 104. A Data-for-Data account holder contributes data and/or documents to the Indico Data Collection, and the account holder receives the right to retrieve other data and/or documents from the Indico Data Collection, including those contributed by other customer accounts. That is, these accounts swap their own data and/or documents for the right to access other's data and/or documents. For instance, in one embodiment, the Data-for-Data account is said to receive “credits” in exchange for its contribution of resumes. The account can then use the “credits” to access a certain number of available resumes stored in the Aggregated Database 110. When a Data-for-Data account has used up its “credits,” the account holder may retrieve resumes from the Aggregated Database 110 for a fee.

Yet another type of customer account is called a Data Purchaser Account 104. Holders of this type of accounts do not contribute data and/or documents, but are consumers of data and/or documents (and may also have software accounts on a paid/subscription basis). It is contemplated that these account holders will pay the Document Broker for the data and/or documents they retrieve.

Yet another type of customer account is Software User Accounts (not shown). Holders of this type of accounts do not contribute data and/or documents to the Aggregated Database 110. However, they will pay the Document Broker for the right to use the Document Broker's productivity software. These accounts may use the productivity software to store, edit or create private data and/or documents in the database, but those data and/or documents are not available to any other accounts. Thus, those documents are not considered to be part of the Indico Data Collection and available for review and purchase, even though they are part of the data stored within Aggregated Database 110.

Yet another type of customer account is called Private Data Network (PDN) Account 108. Referring now to FIG. 1B, multiple Private Data Networks are shown. Private Data Networks herein refer to the entire collection of data/documents stored within the Aggregated Database 110 by a group of affiliated organizations/constituents. Private Data Network Collections herein refer to the collection of data/documents within the Private Data Networks that can be accessed by affiliated organizations and that can be reviewed by such affiliated organizations. PDN Collections, however, are not accessible by accounts or organizations not affiliated with the PDN. PDN Accounts 108 are accounts that may access the Private Data Networks. Note that PDN Accounts 108 may be Software-for-Data Accounts, Data-for-Data-Accounts, Software-only Accounts, Data Purchaser accounts, or any permutation or combination thereof. PDN Accounts 108 may provide data/documents to the Indico Data Collection or Private Data Network Collections in exchange for the right to use productivity software and/or the right to retrieve data/documents from the Indico Data Collection or Private Data Network Collections.

Holders of PDN Accounts that share the same Private Data Network Collection are contemplated to be primarily companies, organizations, or trade groups somehow affiliated with each other. For instance, the portfolio companies of a venture capital firm or a group of customers of a third party recruitment agency may be holders of PDN Accounts 108 affiliated with the same Private Data Network.

PDN Accounts 108 may contribute data/documents to an affiliated PDN collection in exchange for the right to use productivity software or the right to retrieve data/documents from the same PDN Collection (PDNC) and/or from the Indico Data Collection. It is contemplated PDN Accounts 108 may retrieve data/records from the affiliated PDNC or the IDNC (Indico Data Collection) for a fee. It is also contemplated that the PDN Accounts 108 may pay a fee to use the productivity software provided by the Document Broker, contributing their data to the PDN collection, but not to the IDC.

PDN Accounts 180 may use the productivity software provided by the Document Broker to store Private Data (e.g., private resumes) within the Aggregated Database 110. Such Private Data is not accessible to anyone other than the account holder and/or affiliated PDN accounts.

It should be noted that some accounts may have characteristics of permutations and combinations of different types of accounts. For example, an organization may have an account where the organization can trade software for data, purchase data with credits and participate in a PDN.

It should also be noted that an account may contribute documents to the aggregated database without literally storing a document in the database. Rather, an account may receive credits by giving the Data Broker the right to contact the original document creator (e.g., person who wrote the resume) for the purpose of securing their approval to reuse/resell their document.

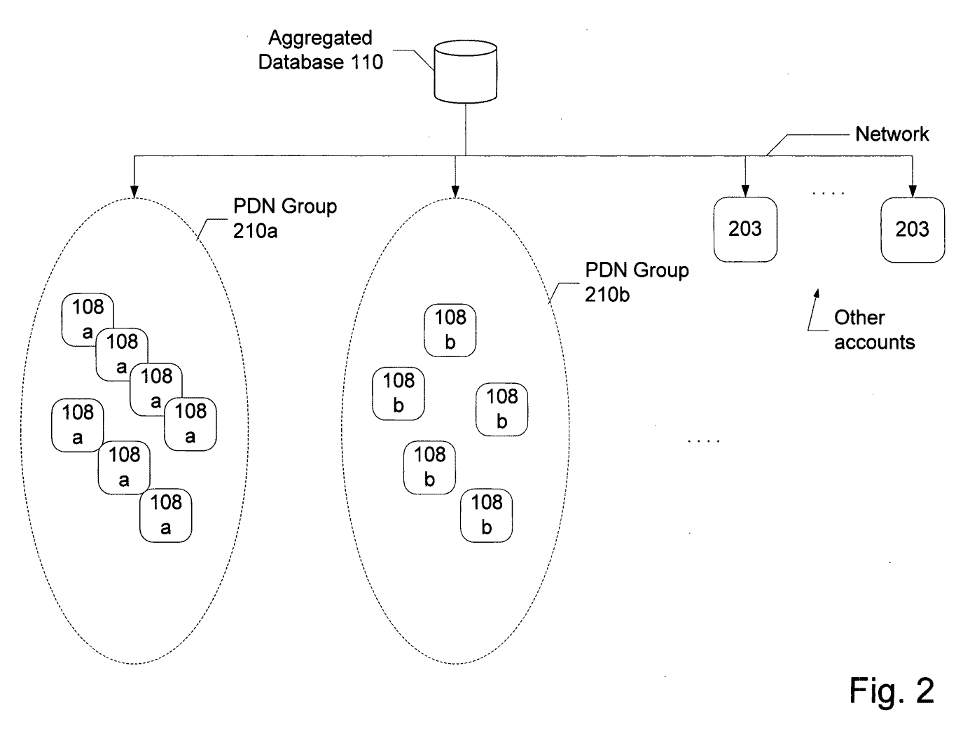

FIG. 2 depicts a plurality of PDN Accounts 108a and 108b. PDN Accounts 108a, which are affiliated with PDN Group 210a, may provide data to the same PDNC. from which they may access and retrieve data and/or documents themselves, while PDN Accounts 108b, which are affiliated with PDN Account Group 210b, may provide data and/or documents to another PDN from which they may access and retrieve data and/or documents therefrom. The PDN Accounts 108a-108b can retrieve data and/or documents from the Indico Data Collection (e.g., data and/or documents contributed by other accounts 203), but the other accounts 203 may not retrieve data and/or documents within the PDN Networks. Nor could PDN Accounts 108a access data and/or documents contributed by PDN Accounts 108b. In other words, the access privileges differ among different accounts. And the access privileges may change according to the amount of data/documents contributed, the amount of money paid, the amount of productivity software used, etc.

For simplicity, users or companies that provide data and/or documents to the Indico Data Collection and/or the PDNCs are called “contributors” regardless of what they receive in exchange for their contribution and regardless of what type of accounts they have set up. According to an embodiment of the invention, some contributors may have implemented therein a mechanism for receiving resumes from various job applicants. Some of the contributors may further have their own resume databases in which the submitted data/resumes are stored. Furthermore, some contributors may have a mechanism for uploading resumes they have in their possession to the Aggregated Database 110. Documents obtained by the contributors through uploading or use of productivity software (ATS) may include resumes submitted via staffing agencies, resumes collected via online job boards or resume pools, resumes collected via direct submissions and those collected by means of internal referral and other sources. Some of the contributors may directly contribute their resumes to the Aggregated Database 110.

According to an embodiment of the invention, the Aggregated Database 110 is accessible to the contributors and/or customers through a Web interface. Through this Web interface, the Document Broker may provide productivity software as an Application Service Provider (ASP). For example, the Document Broker may provide human resource management and recruiting software that performs the following functions:
Posting of job advertisements. The Document Broker may provide software mechanisms with or without fees for creating online job advertisements and for posting job advertisements on various job boards and Web-sites.
Receiving and storing job applications. The Document Broker may provide software mechanisms with or without fees for receiving job applications corresponding to the posted job advertisements and storing and parsing the job applications, include resumes, on the Aggregated Database. The user/account may tag resumes as Private Data, or as part of the Indico Data Collection (or, if the user has a PDN Account, designate the resumes as part of a PDN Collection).
Applicant tracking. The Document Broker may provide with or without fees Applicant Tracking System (ATS) software mechanisms enabling contributors and/or customers to manage their resumes and data and track their job fulfillment processes from start to finish. Applicant Tracking System (ATS) software is provided with or without fees to contributors of resumes and other customers. The ATS software mechanism may provide functionalities such as resume reviewing, interview scheduling, referral gathering, collection of interviewer feedback, reporting, etc. In addition, the ATS software mechanism may automatically generate letters or emails acknowledging receipt of the candidates' applications, generate emails to turn down applicants once a position is filled, and store the resumes as permanent records for the company's own use in the future. The emails may ask the candidates to participate in the network and/or confirm or enter information on the type of job they want, and who can view their resumes, and when can their resumes be viewed, and other factors. Furthermore, the ATS software mechanism stores resumes of applicants that are no longer considered for a position in the Aggregated Database 110.
Meta data generation and collection. An important feature of the ATS software mechanism is that the software keeps track of certain meta data of each applicant. The meta data generally includes information not typically reflected on a resume and not typically provided by the applicant. Meta data may include information such as, but not limited to,
Source and Referral Meta Data (e.g., What is the identity of the referral source? Did the resume come from a classified, direct submission or referral? And the quality of that source: i.e. has it typically been generating candidates that are reviewed, intereviewed, offered jobs, or hired?),
Performance Meta Data (e.g., Was the applicant interviewed after an employer reviewed the resume? Was the applicant offered a position after an interview?), and
Preference Meta Data (e.g., What position is the applicant applying to? What is the location of the job opening to which the applicant is applying?).
The ATS software stores the meta data in the online resume pool together with resume data, although access to the meta data may be limited to those having permission from the operator of the online resume pool or the owners of the meta data. The Meta Data may be used to influence ranking of candidate. A description as to how Meta Data may be used is described in more detail below.
Secure online storage for resumes. The Document Broker may provide with or without fees software mechanisms enabling customers to store private resumes on-line for their own use. These private resumes may be part of the Private Data. Customers with Data purchasing accounts may choose to store/manage their resumes online so that they do not re-purchase resumes/data that they already own.
Viewing and Ranking of Anonymous Candidate Profiles. The Document Broker may provide with or without fees software mechanism that enables contributors to view relevant Anonymous Candidate Profiles corresponding to resumes that are part of the Indico Data Collection (IDC). Anonymous Candidate Profiles may be ranked according to their relevance to the requisites of a particular job advertisement and according to the meta data associated with the applicants. Aspects of the invention relating to the Anonymous Candidate Profiles are discussed in detail further below.
Purchasing and Viewing of Full Resumes. The Document Broker may provide software mechanisms that enable contributors to contact the candidates whose Anonymous Candidate Profiles they deem appropriate. In addition, the Document Broker may provide software mechanism that enable contributors to purchase and view relevant complete resumes corresponding to Anonymous Candidate Profiles they deem appropriate. The software mechanisms may dynamically adjust the purchase price of a resume according to its relevance with respect to requisites of a job opening and its ranking relative to other available resumes, which may be based on meta data.

According to an embodiment of the invention, the Document Broker may provide the aforementioned and other productivity software to the contributors free of charge or at a very low cost in exchange for contribution of resumes.

It is expected that some contributors may not desire to contribute resumes of their own employees and resumes of those they are currently interviewing for their own job openings. However, it is contemplated that contributors may want to contribute resumes to the Indico Data Collection (or a PDNC) when openings are filled, for instance. Some contributors may have a collection of older resumes which they no longer deem useful, and the contributors may choose to contribute those resumes to the Indico Data Collection (or a PDNC). If a contributor uses applicant tracking software mechanisms provided by the Document Broker, it is expected that a workflow and set of rules will be established regarding when resumes and data are automatically contributed to the IDC/PDNC based on data age, data privacy, data source, job management/progression, etc.

Contributors may be allotted a predetermined number of resumes within the Indico Data Collection (or a PDNC) that they can access without charge. For instance, once a contributor has contributed a number of resumes, the contributor may be allowed to access a certain number of resumes from the Indico Data Collection without charge. (The number of resumes accessible without charge may depend on the number of resumes contributed.). In one embodiment, a contributor may be given monetary credits for the number of unique records they contributed to the Indico Data Collection. An entity who did not contribute resume to the Indico Data Collection may be charged for accessing the collected records. A PDN contributor may, for instance, be able to access all records of their affiliated PDNC free of charge.

Note that not every resume stored within the Aggregated Database 110 is part of the Indico Data Collection or part of any PDN Collection. In one embodiment, users of the productivity software (provided by the Document Broker) may choose to store resumes on the Aggregated Database 110 without allowing other account holders to access the resumes. In one embodiment, the applicants/candidates themselves may need to make their information available or not available to the other constituents of the system.

According to a preferred embodiment of the invention, the Document Broker further provides a mechanism for generating anonymous candidate profiles from the parsed fielded information of resumes stored within the Aggregated Database 110. In a preferred embodiment, an anonymous candidate profile is a concise synopsis of the candidate's qualifications but does not include information that may be used to uniquely identify the candidate. For example, an anonymous candidate profile may include generic information such as graduation dates, degrees obtained, and job titles, employment dates, job skills, etc., but may not include information such as name, contact information, current employer, or school attended. In a preferred embodiment of the invention, account holders of the Aggregated Database 110 may access all of the anonymous candidate profiles in the IDC without charge, but they may be charged for accessing the candidate's name and contact information. The charge may be imposed as a basic subscription charge, which will entitle a customer to retrieve a predetermined number of resumes. Another charge may be imposed for all requests above and beyond the basic subscription level. The charge may be imposed as a per-resume transaction charge as well.

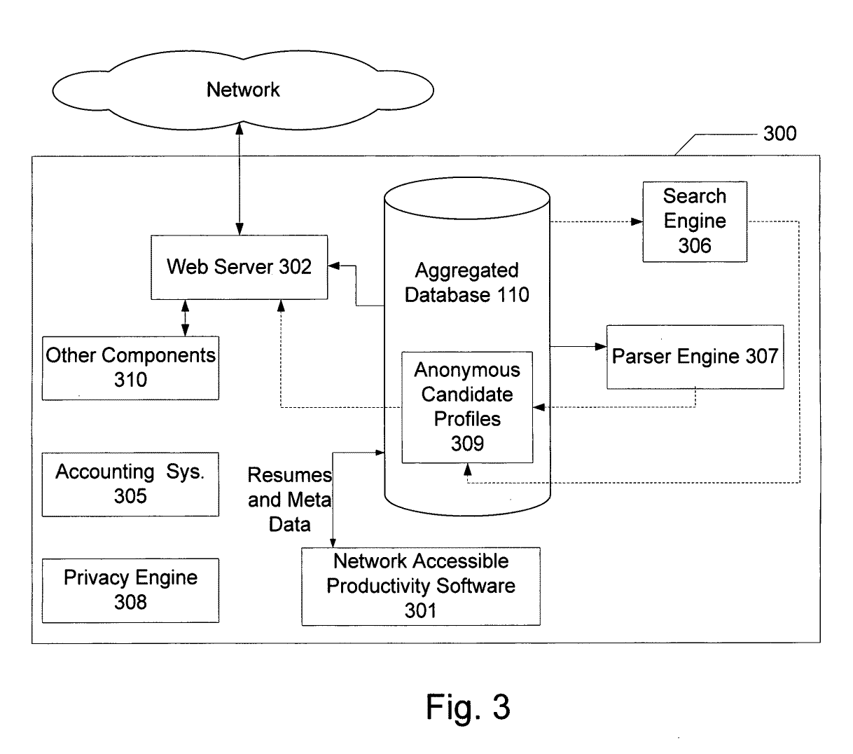

FIG. 3 depicts some components of an implementation of a system 300 according to an embodiment of the invention. It is to be understood that the system 300 can be implemented using general purpose computer hardware as a network site. The general purpose hardware may advantageously be in the form of a Unix or Linux server or other suitable computer. The hardware may execute various software modules, which may include: communications software of the type conventionally used for Internet communications, and a database management system. Any number of commercially available database management systems may be utilized.

As shown, the system 300 includes a Web-server 302 to allow users to access to the system through communications with other computers connected to a network. According to a preferred embodiment, the network may include access over the Internet to any number of external computer systems or access through local or wide area network to other connected computers either directly or through modems. Conventional software techniques such as CGI programs, PERL scripts, ODBC, etc. may be used to allow access to components of the system 300 via a Web-interface.

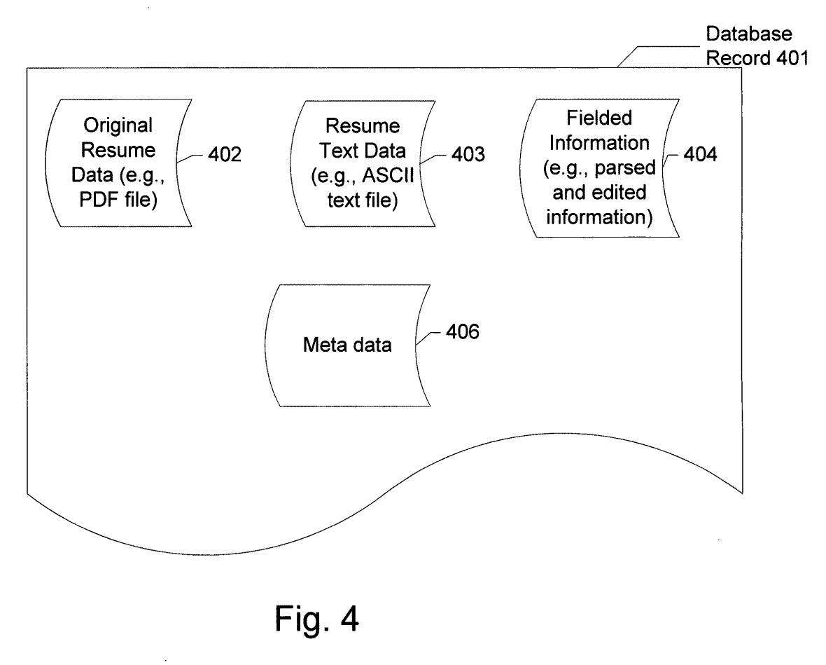

The system 300 includes an Aggregated Database 110, which may be in the form of a data file comprised of a plurality of records, each record corresponding to a resume. An example record is depicted in FIG. 4. As shown in FIG. 4, each record may include a resume in the format it was submitted (e.g., PDF format), resume text data (which may be in ASCII or MS Word format and which may be obtained by using Optical Character Recognition (OCR) software or obtained manually), fielded information containing search parameters and additional fields containing descriptive information of the skills and experience of the job applicant (which may be obtained by parsing and editing the fielded information). The resume text data may be indexed for general resume keyword searches, and the fielded information may be indexed for fielded searches or ranked fielded searching. The search parameters may include fields, such as: names, school attended, degree obtained, graduation date, etc. Each record in the system may further include Meta Data, which may consist of information about the record, such as entry date, edit date, what users and or accounts have access to this record at the current time, and other variables, and other information tagged on by software. As used herein, Meta Data refers information other than that provided by the information provider (e.g., job applicant's resume document). The Meta Data may come from ATS user logfiles that captured user activities (e.g., a record is clicked on for review) or ATS event logfiles that captured system events (e.g., a record expired, was purchased by another employer, etc.). In the employment context, Meta Data may include, but is not limited to, Preference Meta Data (e.g., the type of positions a candidate has previously applied for) and Performance Meta Data (e.g., how the resume has been used by one or more users, the number of times a candidate has been requested for an interview, the number of times job offers have been extended to the candidate, the number of times a candidate's resume has been purchased, etc. The Meta Data may further include Referral Meta Data (e.g., information about how the resume come into the system). The Meta Data may further include information that is derived from the other data, such as total number of years of work experience. According to one embodiment, the Meta Data may be gathered through the use of productivity software (e.g., ATS software) that is provided by the Document Broker. In a preferred embodiment of the invention, each applicant/candidate is assigned a unique identifier (e.g., an identifier that corresponds to a social security number) such that their Performance Meta Data can be tracked over time.

In one embodiment, the Meta Data may be associated with users/customers and accounts. For instance, previous behavior of an employer in terms of the types of candidates selected, jobs filled, sources used could be used to improve the relevancy match to identify the most relevant candidates for that employer. This customer information could be extrapolated from logfiles captured by the ATS software mechanism, or these preferences might be captured through an advanced search user interface provided by the Aggregated Database. Other information may be extrapolated or extracted from the log files. For example, from the logfiles that captured all the activities of the ATS users, the following information can be obtained: what are the characteristics, what sources have yielded good/relevant candidates, what has been working to find appropriate candidates, who are a company's best referral sources, etc. All of this metadata is dropped into the database and may be used to improve relevancy matching.

According to one aspect of the invention, the Meta Data is used to identify and determine qualified or sought-after candidates. In one embodiment, the Meta Data is used to influence the search results, for instance by producing a ranking in which a highly qualified candidate is listed before a less highly qualified candidate. Meta Data may also be used to determine or influence the purchase price of a candidate's resume. For instance, resumes for highly qualified or sought-after candidates may be purchased at a higher price than less highly qualified candidates. Heretofore, Meta Data collected based on the use of an applicant tracking system by multiple constituents has not been used to build improve the ability of a system to identifying/match candidates or set resume prices in the employment/recruitment context.

With reference again to FIG. 3, the resumes of the Aggregated Database 110 may be collected from a plurality of contributors. In one embodiment, some of the contributors have incorporated in their own computer systems' data extraction modules, which may be configured to retrieve old resumes records designated for the Indico Data Collection (or a Private Data Network Collection) from the companies' own resumes. Some of the contributors may use the Network Accessible ATS 301 provided by the system 300 to manage their resumes and data and track their job fulfillment processes from start to finish. The Network Accessible ATS 301 may provide functionalities such as resume capturing and verification, resume source tracking, resume reviewing interface, interview scheduling, referral gathering, collection of interviewer feedback, reporting, etc. In addition, the Network Accessible ATS 301 may automatically generate letters acknowledging receipt of the candidates' applications, generate emails to turn down applicants once a position is filled, request permission to resell candidates' resumes through the aggregated network, and store the resumes as permanent records for the company's own use in the future. Furthermore, the Network Accessible ATS 301 stores resumes of applicants that are no longer considered for a position in the Aggregated Database 110 as part of the Indico Data Collection or a Private Data Network Collection (except for those earmarked as private data) in exchange for the right to use the ATS 301 for free or at a reduced cost.

Another feature of the Network Accessible ATS 301 is that the software may generate Meta Data of each resume by keeping track of the referral source of the resume, the job positions applied for, and the contributor's activity with respect to the resume. The Network Accessible ATS 301 stores the Meta Data in the Aggregated Database 110 together with resume data, although the Meta Data may be accessible and used only by or with permission from the operator of the online resume pool. In some cases, the Meta Data collection process is completely transparent to a contributor using Network Accessible ATS 301.

The system 300 may include a search engine 306 which handles queries to the Aggregated Database 110. The resume management module and the search engine 306 may be implemented through commercially available database management systems. Other conventional search technology may also be used to search the resumes of the databases. The system 300 may also include a parser engine 307, which is configured to parse resumes to create the records in the Aggregated Database 110 including resume text data and fielded information. Searchable candidate profiles 309 may be created using parsed, fielded information from the job applicants' resumes with certain information omitted, may be generated using the parser engine 307. Parser engine 307 may be implemented with well known parsing technologies. In an alternative embodiment, searchable candidate profiles 309 may be generated by manually extracting and entering relevant fielded information from the resumes entered into the Aggregated Database 110.

Through the Web interface, account holders of the Aggregated Database 110 may invoke the search engine 306 to search through the searchable candidate profiles 309 and view the search results, which may consist of a list of anonymous candidate profiles. The account holders may search for candidates that meet certain search criteria. In one embodiment of the invention, the anonymous candidate profiles are ranked, and the ranking is based on at least in part information stored as Meta Data of the candidates. Other factors that may influence the ranking includes, but not limited to, user entered information on the factors they deem important, the type of candidate they are looking for, and a text-based match of the resume data against a written job description. For instance, the Meta Data may indicate that a certain applicant is a “relevant” candidate because he/she is often selected for an interview, offered a position after an interview, and he/she has previously applied to similar positions. In that case, the search engine 306 may rank that candidate higher than candidates who have a less successful track record or who have a dissimilar interest or preference. In this way, the search engine 306 provides an additional dimension through which candidates may be differentiated despite similarities of their stated qualifications and professional histories. As a result, the search engine 306 is more likely to present highly qualified candidates to the customers of the online resume pool than search engines that only employ prior art candidate matching/ranking methodologies. It should also be noted the fact that the resumes stored in the Aggregated Database 110 are collected from multiple entities that employed a multitude of means to obtain the resumes from different sources may increase the likelihood of presenting highly relevant candidates to the customers as well.

After previewing the anonymous candidate profiles, the account holders will be presented with the option of accessing additional information corresponding to the candidates they deem suitable for their jobs. In one embodiment, a price may be displayed together with each anonymous candidate profile. The resumes for the higher ranked candidates may require a higher purchase price.

According to one embodiment of the invention, an account holder may be presented with an “anonymous candidate profile view” option where he can browse or search anonymous candidate profiles with or without fee. In that embodiment, fields that can be used to uniquely identify the candidate (e.g., candidate name, contact information, email address, current employer, school attended) are hidden from the account holder. Upon finding the candidates with the desirable qualifications, the account holder may be is presented with a “full record view” option where he can purchase and retrieve the entire resumes for these candidates. In one embodiment, resumes that are identified as highly qualified by the search engine 306 may have a higher purchase price than resumes that are not so identified.

With reference still to FIG. 3, according to one embodiment of the invention, the Network Accessible ATS 301 may provide a user interface through which employers may send generic descriptions of available positions to individuals whose resumes are stored in the Aggregated Database 110 with or without fees. A generic description of a position may include a job title, a description of job requirements and the salary range information, but without information that explicitly identifies the employer. Recipients of the generic descriptions may respond by submitting their resumes to the Aggregated Database 110. An anonymous profile of the candidate may be generated by parser engine 307, and provided to the employer. This process is referred to herein as “double blind matching.” After reviewing the anonymous profile the employer may then choose to send the full job posting to the candidate, or to purchase the candidate's full resume. In other cases, at the candidate's discretion, the candidate's full resumes may be sent to the employers without first sending an anonymous profile. In one embodiment, the employer may be charged a first fee for mailing or emailing generic descriptions of the available positions to candidates that are identified as relevant, and a second fee if one or more of these candidates respond.

According to yet another embodiment of the invention, the Network Accessible ATS 301 may provide a user interface through which an employer may view resumes that are submitted in response to any number of job postings. In that embodiment, the search engine 306 performs a search based on the ranking criteria established by the user, generates a list of anonymous profiles of highly ranked candidates that are not currently in the users' account, but may be found in the paid aggregated database. When the employer views the resumes submitted in response to their own job posting, the Network Accessible ATS 301 may promote other candidates within the resume pool by displaying highly ranked anonymous profiles of those candidates beside the resumes (e.g., there are 10 other resumes that are a 90+% match with your established criteria in the database, would you like to buy them now?). Other statistical information, such as a total number of resumes in Indico Data Collection that are considered “close matches”, may be displayed as well.

The system 300 may invoke an accounting subsystem 305 when an account holder requests to view the contact information or the entire resume of a candidate. According to this feature, the account holder may be charged. The charge may be imposed as a basic subscription charge which will entitle an account holder to view or retrieve a predetermined number of resumes. A predetermined charge may be imposed for all requests above and beyond the basic subscription level. The charge may be imposed as a per-resume charge as well. An account holder may redeem credits to receive resumes. Various other schemes may be utilized to charge the account holder.

Also included in the system 300 are other components 310, which may include a shopping cart module, an account log-in (authentication) module, credit card payment transaction module, and various other software modules commonly used in electronic commerce. The other components 310 may also include software modules that enable the system 300 to provide applicant tracking software (ATS) capabilities as an Application Service Provider.

Also shown in FIG. 3 is a Privacy Engine 308. The Privacy Engine 308 includes a number of rules that keep track of what information is viewable by what user of the system. For example, a rule may indicate that all data/documents of one account may accessed by another account through a PDN. Another rule may indicate that private data/documents may be accessed through the ITN, once they have been stored within the Aggregated Database 110 for a certain period of time. Many other rules for controlling access privileges of the data/documents for both individual users and groups of users (accounts) stored within the Aggregated Database 110 can be applied using the Privacy Engine 308.

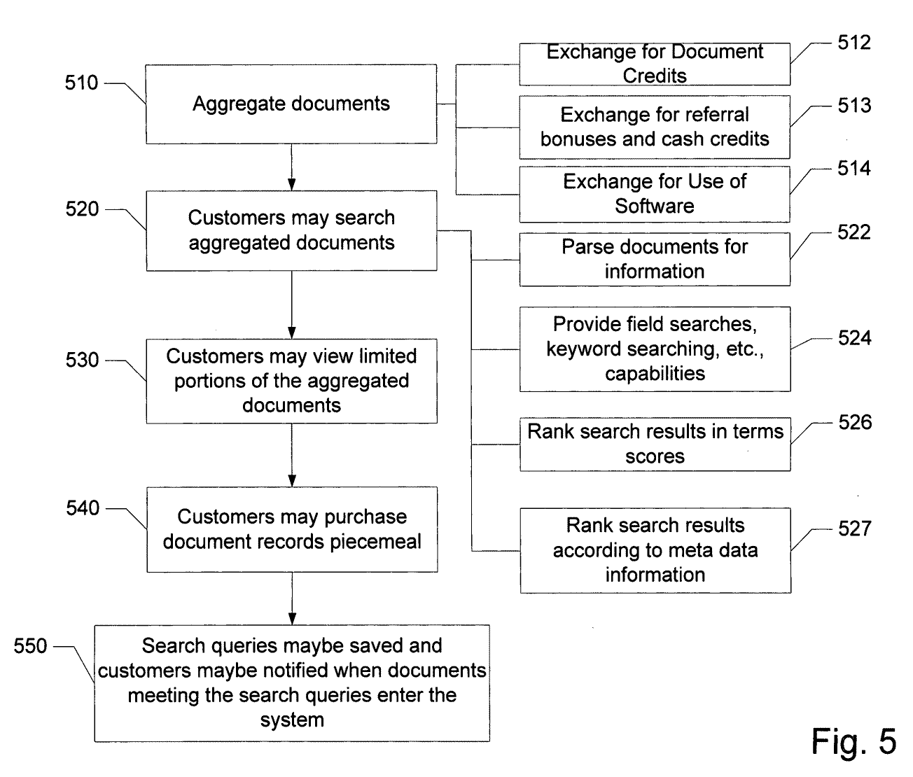

FIG. 5 is a flow diagram depicting a document collection and distribution process according to an embodiment of the invention. As shown, the process begins with the aggregation of documents from multiple sources (step 510). Documents may be collected from multiple contributors, who may receive Document Credits (step 512) and/or the right to use productivity software (step 514) in exchange for the documents they contribute. Naturally, documents may also be acquired through normal commercial means (paid for) or donated to the Aggregated Database 110 free of charge. Resumes may also be acquired through an incentive network program where referral bonuses are paid to people who submit (or refer others who submit) resumes of candidates that are ultimately hired (step 513). A network accessible database may be provided to store the collection of documents.

According to an embodiment of the invention, an incentive network program entails the steps of sending a job description (or a generic description) to a plurality of people, who may or may not be users of the Aggregated Database 110. The description may include information about the referral bonus so as to entice the recipients to contribute resumes to the Aggregated Database 110 and/or to forward the description as part of an email to others. The recipients of the forwarded email may in turn contribute additional resumes and forward the job description to even more people. Conventional techniques are available to trace the forward path of the emails such that a referral chain can be established for each of the submitted resumes. Other techniques may require each forwarded recipient to be registered with the Aggregated Database 110 before they can qualify for the referral bonus. Note that the referral bonus is typically given out by the employers when a referred candidate accepts a job offer. The operator of the Aggregated Database 110 may facilitate the payment of the referral bonus and may charge a service fee. Relevancy ranking may be used to determine whether a job description is passed forward to a recipient (e.g., only jobs that meet certain criteria can come through). Relevancy ranking may be used to determine whether a job description is shown to a certain user.

When a number of documents are aggregated, customers of the network accessible database are allowed to search the document collection (step 520). For simplicity, users or companies that retrieve data and/or documents from the Aggregated Database 110 are called “customers” regardless of what they provide in exchange for their resumes and regardless of what type of accounts they have set up. Customers can be contributors as well, and vice versa.

Because of the diverse formats these documents may have, most documents are parsed before they can be searched (step 522). Search engines may be provided to the customers to search the resumes or fielded information (step 524). A graphical user interface (not shown) may be provided to facilitate fielded searches and to rank and/or make mandatory one or more search categories to yield a ranked list of search results.

With reference still to FIG. 5, the search engines may rank the search results according to how closely the content of the documents match the search criteria (step 526). According to an embodiment of the invention, the search results are ranked according to relevancy to the ranked search criteria. Furthermore, the Meta Data may be used to affect the ranking of a candidate (step 527). For example, the search engines may be configured such that a candidate is ranked higher when the candidate has been requested for an interview many times than a similar candidate who has not been requested for many interviews, or if the candidate was referred by a trusted user rather than sourced through a classified advertisement. Furthermore, collected Meta Data on the customers/employers themselves may be used to improve the relevancy. For instance, previous behavior of an employer in terms of the types of candidates selected, jobs filled, sources used could be used to improve the relevancy match to identify the most relevant candidates for that employer. This customer information could be extrapolated from logfiles captured by the ATS software mechanism, or these preferences might be captured through an advanced search user interface provided by the Aggregated Database 110. For example, if the customer is a company that has never offered a job to someone sourced by a classified advertisement, candidates who typically traffic through classifieds might be ranked lower for that customer, but higher for other customers. In one embodiment, every piece of Meta Data in the system will be attached to a user/customer, an account, a job and a candidate/applicant. The same way that historical Preference, Performance, and Source Meta Data on a candidate may be used to improve matching, the history of any of these other entities could also be used to influence the ability to make a good match. For example, the Meta Data may indicate that a certain user only reads referral resumes. Then, the system may show him more candidates that are referrals or rank referral candidates higher. As another example, the Meta Data may indicate that a certain account only buys resumes with these characteristics. Then, the system may show them more resumes having the desired characteristics, or rank resumes having the desired characteristics higher than those which do not.

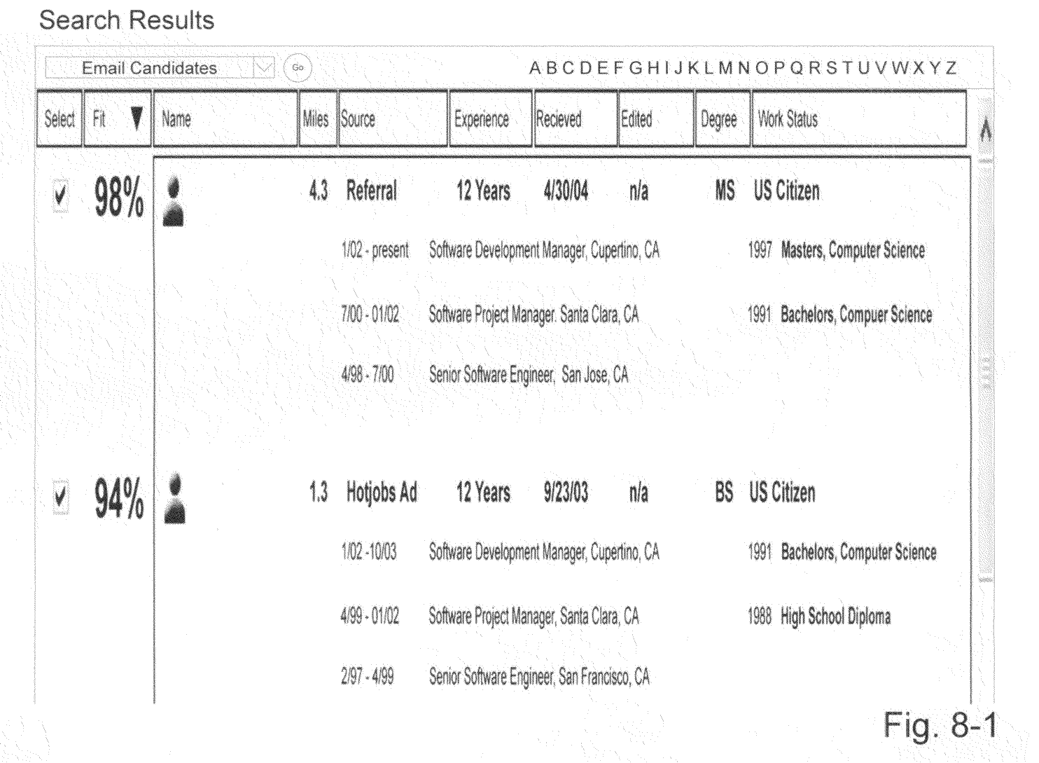

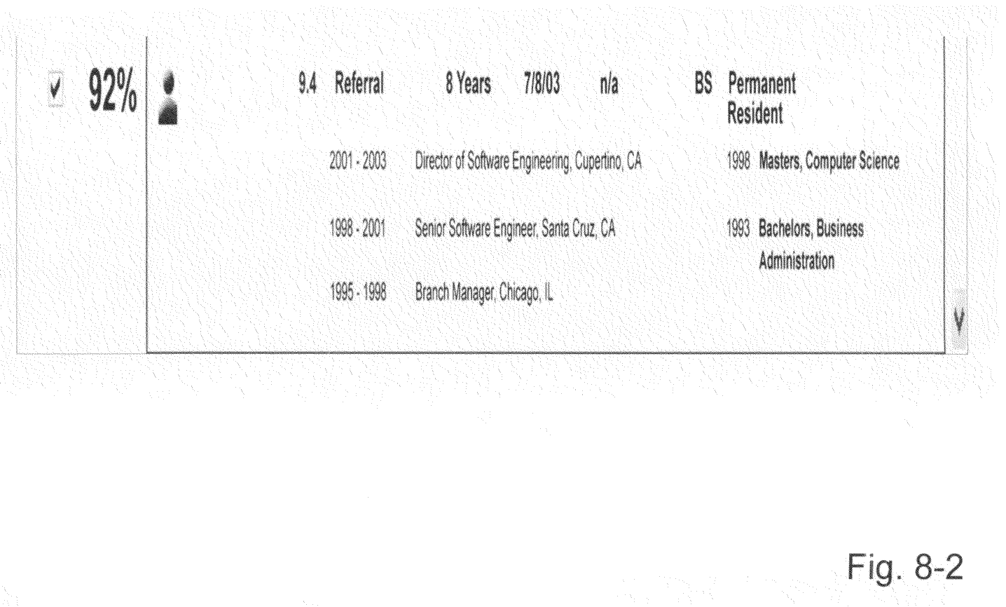

Customers of the network accessible database may be able to view only limited portions of the documents that match their search criteria (step 530). For example, if the documents being searched are resumes, the name, contact information, current employer, and any information that may reveal the identity of the candidate may be omitted from the search results. FIG. 8 depicts the Anonymous Candidate Profile view of the search results. FIG. 8 also depicts the ranking of Anonymous Candidate Profiles in terms of “matching scores,” which may be generated based on at least in part Meta Data associated with the Anonymous Candidate Profiles.

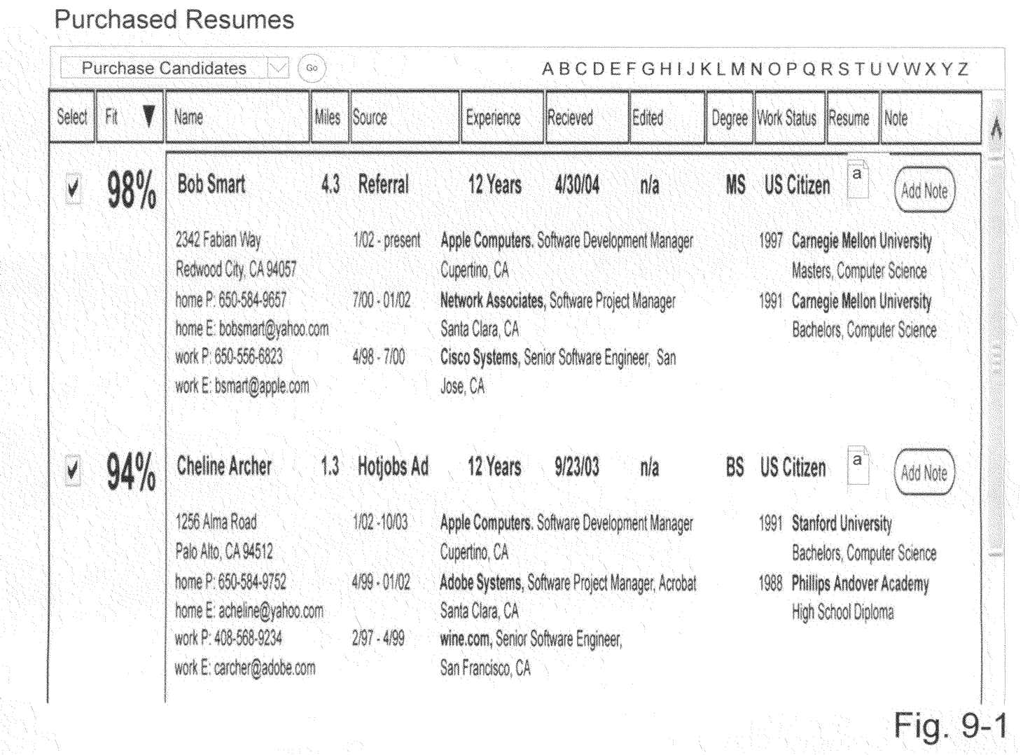

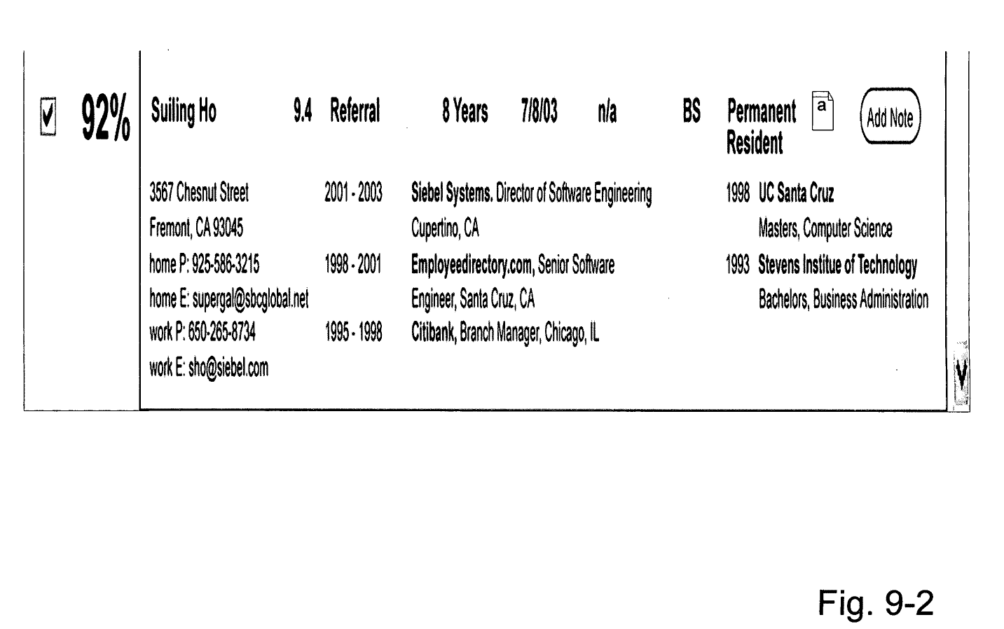

With reference again to FIG. 5, the customers, however, may be able to purchase the documents in their entirety after viewing the limited portions (step 540). For example, if the documents being searched are resumes, the name, contact information, current employer, etc., are displayed after the customer purchased the resumes. FIG. 9 depicts the Full Profile View of the search results. The customer may then retrieve the full resumes that have been purchased. In one embodiment, the Document Broker may charge a price premium for documents that are ranked higher over documents that are ranked lower.

The customer's search criteria may be saved. The network accessible database may periodically run the search queries and notify the customer when new documents meeting the search criteria enter the system (step 550). As an example, in the context of collecting and selling resumes, anonymous candidate profiles may be sent to the customer whenever resumes meeting the search criteria enter the system.

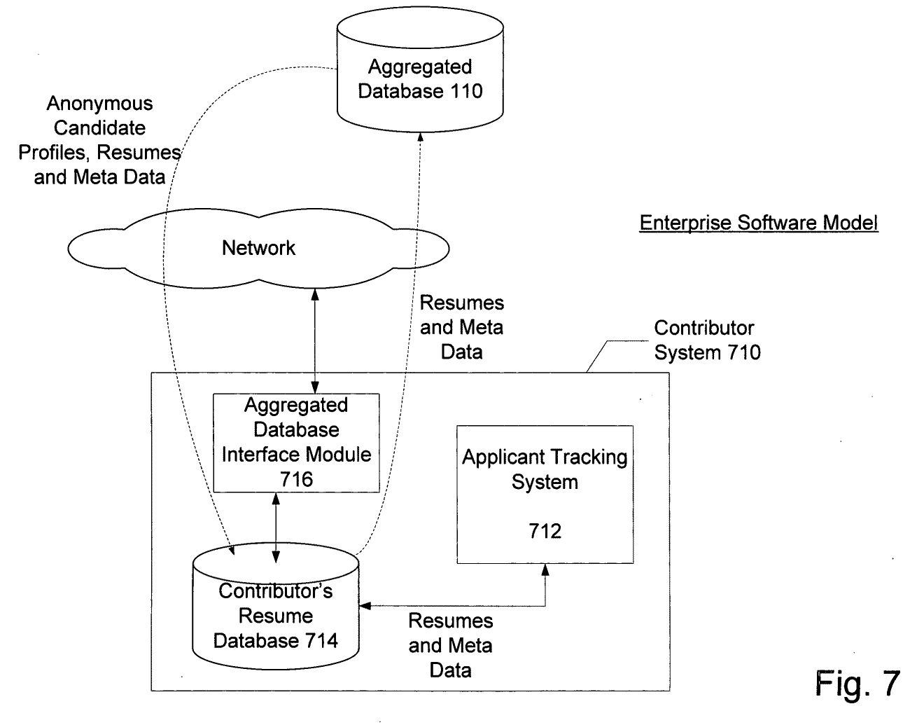

Attention now turns to FIG. 7, which depicts some components of a Contributor System 710 according to one embodiment of the invention. In this embodiment, in addition to or in lieu of providing ATS software as an ASP, the Document Broker may provide software directly to the contributors or customers. It is to be understood that the Contributor System 710 may be composed of software modules that can be executed by a general purpose computer. According to an embodiment of the invention, the Document Broker provides software modules that run on Contributor System 710 without charge or at a substantially reduced cost in exchange for a certain number of (documents) resumes.

The Contributor System 710 may include an Applicant Tracking System (productivity software) 712, which includes a module (not shown) that retrieves anonymous candidate profiles and resumes contained in the Aggregated Database 110 (FIG. 1). The module may present the user of system 710 with an option of showing anonymous candidate profiles that are within the Aggregated Database. The module may also present the user with the option of viewing resumes that are available from the Aggregated Database 110. In one embodiment, the module acts like plug—in. That is, the module is a program that works with an existing enterprise ATS software, such as Resumix or RecruitSoft, and keeps track of what information is in their system so that they do not re-purchase resumes that they already own. The module also keeps track of applicant information and creates Meta Data to be stored with the resumes.

In the embodiment illustrated in FIG. 7, the Applicant Tracking System 712 manages the creation, revision, maintenance, and storage of resumes contained in a Contributor Resume Database 714. In one embodiment, the Contributor Resume Database 714 may be in the form of a data file comprised of a plurality of records, each record corresponding to a resume posted by a job applicant for submission as a job application. The resumes stored within the Contributor Resume Database 714 may be originated from staffing agencies, online job boards (e.g., www.monster.com), direct submission in response to job advertisements posted on the company's Web site, indirect submission through company employees (e.g., internal referrals), and other sources.

The Contributor System 710 may include an Aggregated Database Interface Module 716 that accesses the Contributor Resume Database 714 to retrieve resumes and Meta Data designated to enter into the Indico Data Collection. The Aggregated Database Interface Module 716 may invoke a privacy engine to search resumes designated for the Indico Data Collection. The resumes designated for the Indico Data Collection may be a subset of resumes in the Contributor Resume Database 714. They may be so designated by the contributor or determined automatically. For instance, the presence of a flag in a “resume release” field or by the presence of special characters in a job-identification field of a resume may indicate that it is or is not designated for the Indico Data Collection.

According to an embodiment of the invention, the Aggregated Database Interface Module 716 retrieves searchable candidate profiles and/or Meta Data within the Indico Data Collection (or a Private Data Network Collection). These Candidate Profiles are anonymized and may be reviewed by the user of the Contributor System 710. The user may then purchase resumes corresponding to the Anonymous Candidate Profiles that are deemed interesting to the user.

The meta-data collection and matching techniques of the present invention do not necessarily require that the company be a provider of productivity software, or that the meta-data is necessarily collected through the use of productivity software. This information can be collected through other means.

For example, in one embodiment of the invention, a company could create a system whereby individual job seekers voluntarily enter their own career history information as well as their implicit preference information (a description of their ideal job or preferences like location, salary band, title, etc.). In addition to these job-seeker entered profiles, a company could create technology to aggregate job listings from multiple sources (i.e. one interface through which you could review job listings from many vendors including both commercial sources like job boards as well as company's direct postings on their websites). In turn a company could create a “standard application” interface wherein job seekers could apply to jobs at many different destination organizations using their pre-established profile. In this way the. company could capture information about what jobs candidates were applying for without furnishing technology to employers at all. In short a company could:
1. capture information about job seekers;
2. aggregate job listing from many sources, commercial and non-commercial;
3. provide an interface for job seekers to be able search through and/or to apply to these aggregated jobs;
4. Build a trail of which jobs people are applying for (explicit preference);
5. A company could leverage this information to make higher quality matches between people and jobs, both in terms of recommending jobs for candidates as well as candidates for jobs, providing the underlying data to enable the company to charge for data offerings, and to enable the company to employ matching techniques of the invention to find highly desirable candidates.

A company could accomplish this by managing a job-seeker oriented system with a dedicated job seeking and application interface, per above.

Alternatively, a company could attach a “cookie” or other similar technology to a job seeker's computer to track job seeker behavior as they surf the internet and apply to jobs from different websites and using different systems, effectively capturing information about their preferences. A person of ordinary skill in the art and having the benefit of this disclosure would consider other implementation techniques contemplated herein or otherwise to be within the scope of the invention.

The meta-data could also be accomplished with the use of third party tools: a company could author technology that “plugs in” to existing applicant tracking, job board and other recruitment productivity software to collect the meta-data and resume trail necessary to fuel the matching approaches and business models described above. For example, an organization could write software that leverages the information collected in other people's systems without actually deploying and managing productivity software or a commercial website of its own.

For instance a meta-data trail could be captured and normalized by building software that runs at many different employers that use different productivity software packages as well as commercial online systems and aggregating it into a centralized system.

Finally, a company could employ one or more versions of these techniques to promote data quality. For example, a company could use more than one of these approaches at the same time to build a larger and/or higher quality data set.

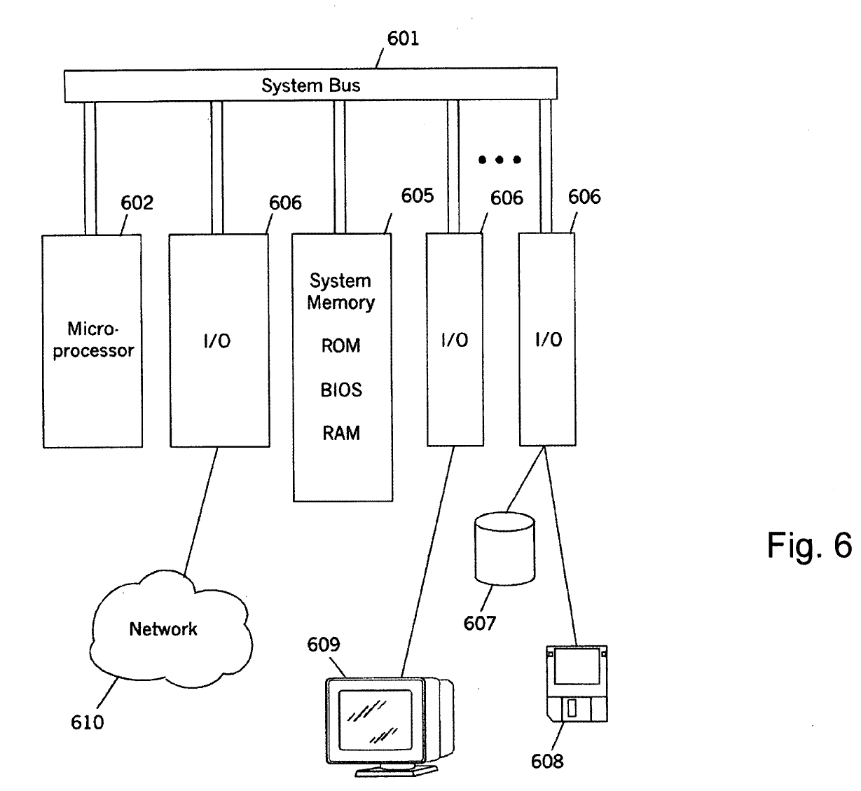

Components of the invention can be implemented through computer program operating on a general purpose computer system or instruction execution system such as a personal computer or workstation, a cable TV set-top box, a satellite TV set-top box or other microprocessor-based platform. FIG. 6 illustrates details of a computer system that is implementing the invention. System bus 601 interconnects the major components. The system is controlled by microprocessor 602, which serves as the central processing unit (CPU) for the system. System memory 605 is typically divided into multiple types of memory or memory areas such as read-only memory (ROM), random-access memory (RAM) and others. The system memory may also contain a basic input/output system (BIOS). A plurality of general input/output (I/O) adapters or devices 606 are present. Only three are shown for clarity. These connect to various devices including a fixed disk drive 607 a diskette drive 608, network 610, and a display 609. Computer program code instructions for implementing the functions of the invention are stored on the fixed disk 607. When the system is operating, the instructions are partially loaded into memory 605 and executed by microprocessor 602. Optionally, one of the I/O devices is a network adapter or modem for connection to a network, which may be the Internet. It should be noted that the system of FIG. 6 is meant as an illustrative example only. Numerous types of general-purpose computer systems are available and can be used.

Elements of the invention may be embodied in hardware and/or software as a computer program code (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system such as the one shown in FIG. 6. A computer-usable or computer-readable medium may be any medium that can contain, store, communicate, or transport the program for use by or in connection with an instruction execution system. The computer-usable or computer-readable medium can be, for example, an electronic, magnetic, optical, electromagnetic, infrared, or semiconductor system. The medium may also be simply a stream of information being retrieved when the computer program product is “downloaded” through a network such as the Internet. Note that the computer-usable or computer-readable medium could even be paper or another suitable medium upon which a program is printed.

The system has been described with reference to a preferred embodiment particularly suited for aggregating and distributing employment related documents. It is to be understood that the system according to the invention is suitable for other applications including the aggregation and distribution of other types of submissions such as real estate listings, technology white papers, research reports, industry trend reports, personal financial information, customer lists, etc. Other documents suitable for the present invention include documents that are valuable. For instance, in the case of a system to aggregate and distribute customer lists, the system may manage customer information and lists rather than resumes as described in accordance with the preferred embodiment. The system may even be used for aggregating and distribution digital media, to the extent permissible by law.

While the invention has been described and shown in connection with the preferred embodiment, it is to be understood that modifications may be made without departing from the spirit thereof. The embodiment described is by way of example and should not be construed as limiting of the claims except where referenced to the specification is required for such construction. For instance, it should also be understood that throughout this disclosure, where a software process or method is shown or described, the steps of the method may be performed in any order or simultaneously, unless it is clear from the context that one step depends on another being performed first. It should be understood by those skilled in the art upon reading the present disclosure that some software processes, which have been described as server-side processes, can be performed as client-side processes, and vice versa. It should also be understood by those skilled in the art that processes that performed via a network can also be done locally.

1-10. (canceled)

11. A network accessible system for identifying high quality job applicants beyond stated qualifications, comprising:
a first subsystem accessible by a plurality of job seekers, wherein said first subsystem provides a job application function that allows said job seekers to each apply for a plurality of jobs by submitting a resume using a unique identifier, wherein said first subsystem generates preference meta data for said job seekers through use of said job application function by said job seekers;
a second subsystem accessible by a plurality of users, wherein said second subsystem provides resume management and annotation functions that allow said users to post job advertisements and to review said resumes, wherein said second subsystem generates performance meta data about said job seekers in reference to specific ones of said jobs through use of said resume management and annotation functions by said users, wherein said second subsystem further generates preference meta data for each of said users through use of said resume management and annotation functions by said users;
a database module for storing said resumes, candidate profiles of said job seekers and meta data generated by said first and second subsystem, wherein said database module provides a mechanism for combining meta data for a specific job seeker generated through use of said resume management and annotation functions by two or more of said users about two or more of said jobs;
a search engine module for searching said database module and for retrieving one or more of said candidate profiles in response to one or more explicit search criteria, wherein said search engine module is configured to rank said retrieved candidate profiles in accordance with at least meta data associated with said job seekers.

12. The system of claim 11, wherein said search engine module is configured to rank said retrieved candidate profiles in accordance with meta data associated with one or more of said users and meta data associated with said job seekers.

13. The system of claim 11, wherein said first subsystem assigns a unique identifier to each of said job seekers such that meta data generated for each of said job applicants by one or more of said users of said second subsystem is collected over time.

14. The system of claim 11, wherein said performance meta data comprises data of actions taken by said users in reference to specific ones of said job seekers and in reference to specific ones of said jobs.

15. The system of claim 11, wherein said preference meta data for said job seekers comprises past behavioral meta data indicative of preferences of said job seekers.

16. They system of claim 15, wherein said past behavioral meta data comprises characteristics of jobs to which said job seekers have applied over time.

17. The system of claim 15, wherein said past behavioral meta data comprises characteristics of employers to which said job seekers have applied over time.

18. The system of claim 11, wherein said preference meta data for said users comprises past behavioral meta data indicative of preferences of said users.

19. The system of claim 18, wherein said past behavioral meta data for an individual one of said users comprises characteristics of selected job seekers to which said individual user has performed at least one of the following: performed assessment of said job seekers, reviewed resumes of said selected job seekers, and requested interviews with said selected job seekers, and extended employment offers to said selected job seekers.

20. The system of claim 19, wherein said characteristics comprise a type of the sources through which resumes are submitted.

21. The system of claim 11, wherein generation and storage of meta data, including preference meta data of said job seekers, performance meta data of said job seekers and preference meta data of said users, is transparent to said plurality of job seekers and said plurality of users.

22. The system of claim 11, wherein said search engine module is configured to filter out one or more of said retrieved candidate profiles in accordance with in accordance with at least meta data associated with said job seekers.

23. The system of claim 11, further comprising a third subsystem coupled to an external system, wherein said third subsystem receives resumes, meta data for job seekers, and meta data for users from said external system.

24. The system of claim 11, further comprising a privacy engine configured to determine which ones of said users have access to which candidate profiles in accordance with at least in part said preference meta data for said job seekers, said performance meta data about said job seekers and said preference meta data for said users.
